(19) United States
(12) Patent Application Publication
(10) Pub. No.: US 2025/0321470 A1
(43) Pub. Date: Oct. 16, 2025

(54) MOUNTING BRACKET, FILTER UNIT, AND PHOTOGRAPHY AUXILIARY DEVICE

(71) Applicant: Shenzhen Leqi Innovation Co., Ltd., Shenzhen (CN)

(72) Inventors: Wei TANG, Shenzhen (CN); Tao JIANG, Shenzhen (CN); Feng QIN, Shenzhen (CN); Nan QI, Shenzhen (CN)

(73) Assignee: Shenzhen Leqi Innovation Co., Ltd., Shenzhen (CN)

(21) Appl. No.: 19/002,765

(22) Filed: Dec. 27, 2024

(30) Foreign Application Priority Data
Apr. 15, 2024 (CN) 202420774442.0
Apr. 15, 2024 (CN) 202420774443.5

(51) Int. Cl. G03B 17/56; G03B 11/00

(52) U.S. Cl. CPC G03B 17/566; G03B 11/00

(57) ABSTRACT

A photography auxiliary device configured for detachably mounting a photographic auxiliary component in front of a camera lens of a photography device, includes a carrying body for detachably carrying the photographic auxiliary component thereon; and a mounting member configured to mount the carrying body to the photography device to thereby mount the photographic auxiliary component in front of the camera lens of the photography device. The carrying body includes a first light-transmitting portion for allowing light to pass therethrough. The mounting member defines a sliding slot to allow a fastener to pass through. The mounting bracket is mounted to the photography device via a connecting bracket. The position of the carrying body relative to the mounting bracket is adjustable and the position of the mounting bracket relative to the connecting bracket is adjustable such that the position of the photographic auxiliary component relative to the camera lens is adjustable conveniently.

### CROSS REFERENCE TO RELATED APPLICATIONS

The present application claims the priority of Chinese patent applications Nos. 202420774442.0 filed on Apr. 15, 2024, and 202420774443.5 filed on Apr. 15, 2024. All of the above are hereby incorporated by reference in their entirety.

### FIELD

The present disclosure relates to the technical field of photography equipment technology, particularly to a mounting bracket, a filter unit, and a photography auxiliary device.

### BACKGROUND

In some photography scenarios, photographic auxiliary equipment is needed to be mounted in front of camaras lens of photography devices to assist in imaging and improve imaging quality.

In order to improve the imaging quality, photographers typically place filters in front of the camera lens or camcorder lens. Filters are usually mounted in front of the lens by a mounting bracket for blocking ultraviolet lights, protecting the lens, and adjusting photographic effects.

In the prior art, the mounting bracket usually has an integral structure and cannot be detached or adjusted, which lacks flexibility. When the mounting bracket is applied to different photography devices with camera lenses at different positions, the positions of the photography devices relative to the mounting bracket are needed to be adjusted, resulting in poor compatibility. Furthermore, position adjustment of the photography devices relative to the mounting bracket is not convenient.

### SUMMARY

Thus, it is desired to provide an improved mounting bracket, a filter unit, and a photography auxiliary device.

In one aspect, the present disclosure provides a mounting bracket configured for detachably mounting a photographic auxiliary component in front of a camera lens of a photography device. The mounting bracket comprises a carrying body configured for detachably carrying the photographic auxiliary component thereon, the carrying body comprising a first light-transmitting portion for allowing light to pass therethrough; and a mounting member configured to mount the carrying body to the photography device to thereby mount the photographic auxiliary component in front of the camera lens of the photography device, the mounting member defining a sliding slot extending in a first direction to allow a fastener to pass through in a second direction perpendicular to the first direction, the fastener being slidable in the sliding slot in the first direction.

In some embodiments, the mounting member comprises at least two spaced connecting arms extending from the carrying body; and each of the connecting arms defines one said sliding slot to allow one said fastener to pass through to detachably connect with the photography device.

In some embodiments, an acute angle is formed between the at least two spaced connecting arms.

In some embodiments, an intersection point of extended lines of the sliding slots is located at a center of the first light-transmitting portion.

In some embodiments, the first light-transmitting portion is a through hole passing through the carrying body.

In some embodiments, the at least two spaced connecting arms comprises a first connecting arm extending from the first annular body and a second connecting arm extending from the second annular body; and the first light-transmitting portion is formed at the first annular body.

In some embodiments, the carrying body further comprises a third annular body connected to the first annular body and the second body; the first annular body forms a first connecting thread, the third annular body forms a second connecting thread in threaded engagement with the first connecting thread; and the first annular body comprises a first limiting portion formed at an outer wall thereof, the third annular body comprises a second limiting portion formed at an outer wall thereof, an annular groove is formed between the first limiting portion and the second limiting portion, and the second annular body is received in the annular groove.

In some embodiments, the mounting member further comprises a second light-transmitting portion such that light can sequentially pass through the first light-transmitting portion and the second light-transmitting portion before entering into the camera lens of the photography device; the fastener is configured to connect the mounting member and the carrying body and lock the carrying body with the mounting member when being tightened; and a position of the fastener relative to the mounting member or the carrying body is adjustable.

In some embodiments, the mounting member comprises a pair of said sliding slots located at opposite sides of the second light-transmitting portion, and the carrying body comprises a pair of sliders which are slidable in the sliding slots respectively; and the fastener extends through one of said sliding slots for locking the carrying body with the mounting member.

In some embodiments, the mounting member and the second light-transmitting portion both are substantially rectangular; and opposite ends of the second light-transmitting portion extend beyond opposite ends of each of the sliding slots.

In some embodiments, the carrying body defines a through hole aligned with one of the sliding slots; the fastener comprises a threaded rod and a nut, the threaded rod extends through the through hole and said one of the sliding slots in sequence, and the nut is sleeved on an end of the threaded rod opposite to the mounting member; and the mounting bracket further comprises a limiting block located at a side of the mounting member opposite to the carrying body and engaged with another end of the threaded rod.

In some embodiments, an anti-skip portion is provided at a circumferential surface of the nut.

In some embodiments, a pair of limiting slots is provided at a side of the mounting member opposite to the carrying body, and each of the limiting slots is in communication with a corresponding one of the sliding slots for receiving a correspond one of the sliders.

In some embodiments, the first light-transmitting portion is a first through hole passing through the carrying body, and the second light-transmitting portion is a second through hole passing through the mounting member.

In some embodiments, the carrying body comprises a magnetic attraction member arranged at a surface thereof opposite to the mounting member, the magnetic attraction member being arranged around the first through hole.

In some embodiments, the carrying body comprises an internal thread around the first through hole.

In another aspect, the present disclosure provides a filter unit comprising a filter and a mounting bracket described above, the filter acting as the photographic auxiliary component.

In further another aspect, the present disclosure provides a photography auxiliary device configured to be detachably mounted to a mobile terminal with a photography device, comprising a mounting bracket described above; and a connecting bracket configured to connect the mounting bracket to the mobile terminal, the connecting bracket comprising a connecting structure configured to detachably connect to the mobile terminal. The position of the carrying body relative to the connecting bracket is adjustable; and the sliding slot is named as first sliding slot, the connecting bracket comprises a second sliding slot extending in a third direction which is angled to the first direction.

In some embodiments, the mounting member comprises two spaced connecting arms extending from the carrying body; and each of the connecting arms defines one said first sliding slot; the connecting bracket defines a pair of said second sliding slots; and the photography auxiliary device comprises a pair of said fasteners each of which passes through one said first sliding slot and one said second sliding slot such that the carrying body is movable relative to the connecting bracket.

In some embodiments, the mounting bracket further includes a limiting member arranged between each of the connecting arms and the connecting bracket in the second direction; and each limiting member defines a through hole in the second direction to allow the fastener to pass through and a limiting slot extending in the first direction to allow a corresponding one of the connecting arms to pass through.

In some embodiments, the carrying body defines a through hole, the fastener extends through the through hole and the first sliding slot such that a locking position of the carrying body locked with the mounting member is adjustable; and the photography auxiliary device further comprises another fastener which extends through the second sliding slot such that a locking position of the mounting member locked with the connecting member is adjustable.

In some embodiments, a groove is arranged at one of the mounting bracket and the connecting bracket, and a hook is arranged at another one of the mounting bracket and the connecting bracket for engaging in the groove

### BRIEF DESCRIPTION OF THE DRAWINGS

Implementations of the present disclosure will now be described, by way of embodiment, with reference to the attached FIG.S. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is an assembled view of a mounting bracket according to a first embodiment of the present disclosure.

FIG. 2 is an exploded view of FIG. 1.

FIG. 3 is a side view a carrying body of the mounting bracket of FIG. 1.

FIG. 4 a sectional view along line A-A of FIG. 3.

FIG. 5 illustrates a limiting member of the mounting bracket of FIG. 1.

FIG. 6 illustrates the mounting bracket of FIG. 1 mounted on a connecting bracket.

FIG. 7 is an exploded view of FIG. 6.

FIG. 8A illustrates a photographic auxiliary equipment being mounted in front of a photography device of a mobile terminal via the mounting bracket of FIG. 1 and a connecting bracket.

FIG. 8B is an exploded view of FIG. 8A.

FIG. 9 is a perspective view of a mounting bracket according to a second embodiment of the present disclosure.

FIG. 10 is another perspective view of the mounting bracket of FIG. 9.

FIG. 11 is an exploded view of FIG. 9.

FIG. 12 illustrates a mounting member of the mounting bracket of FIG. 9.

FIG. 13 illustrates a slider of the mounting bracket of FIG. 9.

FIG. 14 illustrates the mounting bracket of FIG. 9 being mounted on a connecting bracket.

FIG. 15 is an exploded view of FIG. 14.

The realization of the aim, functional characteristics, advantages of the present disclosure are further described specifically with reference to the accompanying drawings and embodiments.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion in the so-described combination, group, series, and the like. the present disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the said features. In the description of embodiments of the application, “a plurality of” means two or more, unless otherwise specifically defined.

The present application provides a mounting bracket configured for detachably mounting a photographic auxiliary component in front of a camera lens of a photography device. In this embodiment, the photography device is a device with a camera lens, such as a camera or a smartphone and so on. The photographic auxiliary component can be a filter or a hood device and so on. The filter, as one of the commonly used photographic auxiliary components, can be used to block ultraviolet light, protect the camera lens, and improve photographic effects. The filter can be UV (ultraviolet) filters, skylight filters, polarizing filters, ND (neutral density) filters, fog filters, etc. The type of the filter can be selected according to the application environment and imaging requirements to satisfy different photographing requirements of users. When the photographic auxiliary component is a hood device, the hood device can block the light leakage area and reduce glare.

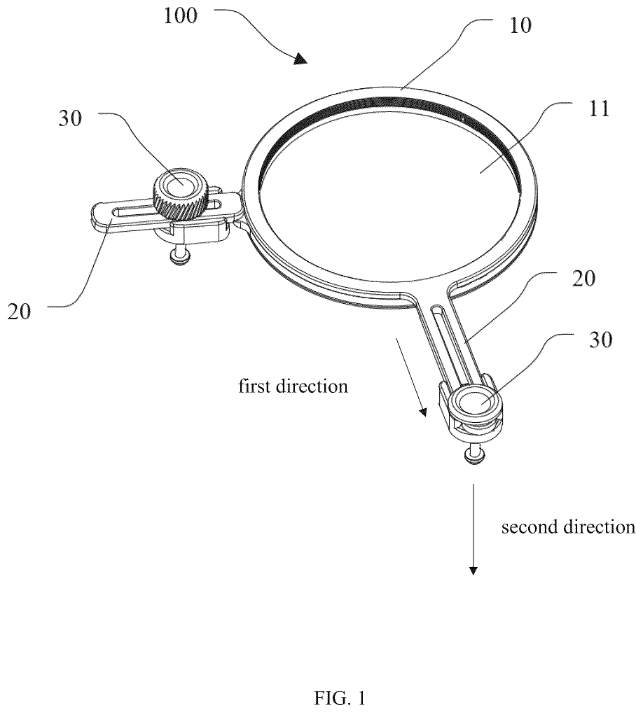

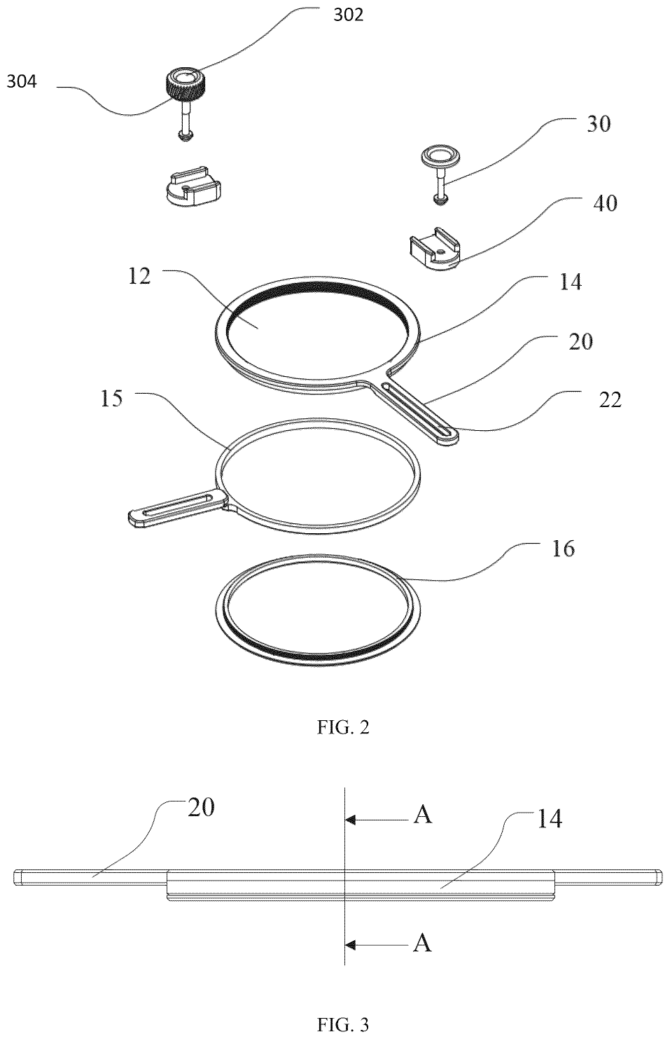

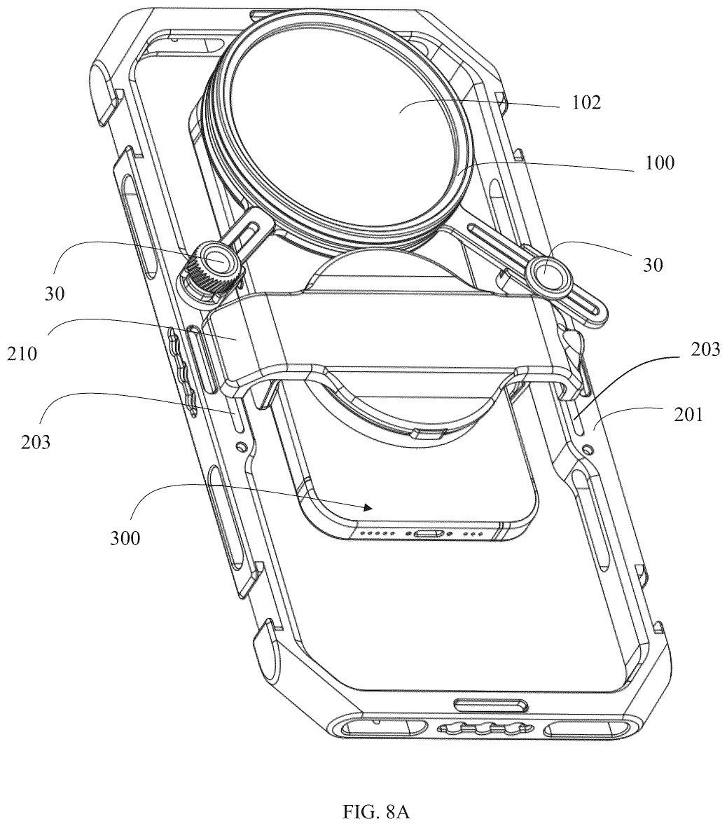

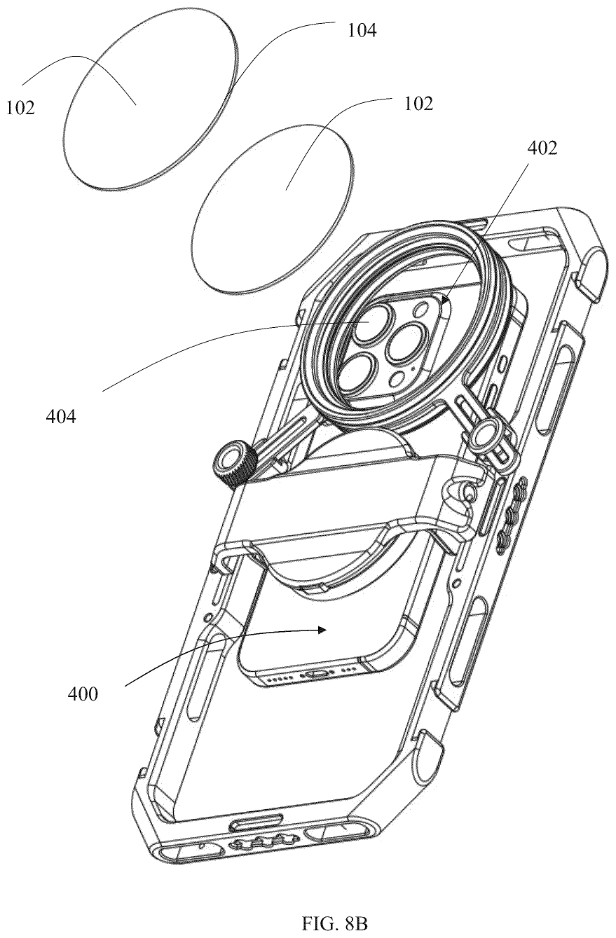

Referring to FIGS. 1 and 2, in this embodiment, the mounting bracket 100 comprises a carrying body 10 configured for carrying a photographic auxiliary component 102 (See FIGS. 8A-8B) thereon and a mounting member configured for mounting the carrying body 10 in front of a photography device 402 (See FIG. 8B).

The carrying body 10 is configured for detachably mounting the photographic auxiliary component 102 thereon, and the carrying body 10 comprises a light-transmitting portion 11 to allow light to pass therethrough.

In this embodiment, the light-transmitting portion 11 is located in front of the cameras 404 of the photography device 402, allowing light to pass through, and the photographic auxiliary component 102 is mounted at the light-transmitting portion 11. When the photographic auxiliary component 102 is a filter, it can be used to filter light, such as eliminating the impact of ultraviolet light and stray light in natural light on the sensitivity of the film. In addition, the filter can protect the camera lens.

The detachable mounting ways can be a snap connection, threaded connection, magnetic attraction connection, etc., which facilitates the detachment and installation of the photographic auxiliary component and the carrying body 10.

In this embodiment, the mounting member includes at least two connecting arms 20 which are spaced apart from each other in a circumference direction of the carrying body 10. One end of each of the connecting arms 20 is connected with the carrying body 10. Each of the connecting arms 20 defines a first sliding slot 22 extending in a first direction to allow a fastener 30 to pass through in a second direction such that the connecting arms 20 can be detachably mounted in front of the photography device 402 via the fastener 30. The fastener 30 can be a threaded rod with a nut, but not limited to this.

In this embodiment, the fasteners 30 can be used to pass through the first sliding slots 22 to detachably connect with the photography device, and the carrying body 10 and the photographic auxiliary component are detachably assembled together, making the mounting bracket 100 of this application have a modular structure, which can be detached or installed according to user needs. Therefore, the mounting bracket 100 of this application has advantages of easy to assemble, and the installation position of each module being flexibly adjustable, and good compatibility.

In some embodiments, the connecting arms 20 and the first sliding slots 22 are elongated. Each of the connecting arms 20 extends from the carrying body 10 in the first direction. The first sliding slot 22 extends along the length direction (the first direction) of the connecting arm 20 and the first sliding slot 22 passes through the connecting arm 20 in the height direction (the second direction) of the connecting arm 20 such that the fastener 30 can slide in the first sliding slot 22 along the length direction of the first sliding slot 22 and the connecting arm 20. In this embodiment, by moving the connecting arms 20, the fasteners 30 slide in the corresponding first sliding slots 22, thereby adjusting the position of the carrying body 10 relative to the photography device 402. Thus, the position of the photographic auxiliary component 102 relative to the photography device 402 can be adjusted such that the photographic auxiliary component 102 is applicable for photography devices 402 of different sizes and positions. Therefore, the mounting bracket of the present application has a good compatibility and can be adjusted conveniently, which facilitates to improve photo quality of the photography devices, and enhance user experience. Furthermore, the operation of the mounting device is easy and simple.

In some embodiments, the number of the connecting arms 20 is two, and the two connecting arms 20 are spaced apart in a V-shape around the outer circumference of the carrying body 10. An acute angle is formed between the two spaced connecting arms 20. Preferably, the carrying body 10 is ring-shaped and the first light-transmitting portion 11 is circular. Each of the connecting arms 20 extends from the circumferential surface of the carrying body 10 in a radial direction. An intersection point of extended lines of the sliding slots is located at a center of the first light-transmitting portion 11. Correspondingly, there are two fasteners 30, each fastener 30 cooperates with one first sliding slot 22. Each fastener 30 can serve as a pivot point, allowing the carrying body 10 to rotate around the fastener 30 and the other fastener 30 to slide in the corresponding first sliding slot 22, such that the carrying body 10 can slide relative to the photography device in a left and right direction and an up and down direction of the photography device, to thereby adjust relative positions between the photographic auxiliary component 102 and the photography device 402. The operation is easy and convenient.

Of course, it is also possible not to use the fastener 30 as a pivot point for adjustment. For example, the two fasteners 30 are loosened, and the carrying body 10 is then operated to drive the connecting arms 20 to slide relative to the fasteners 30. When the carrying body 10 reaches the preset position, and the two fasteners 30 are tightened at the same time. The position adjustment of the carrying body 10 relative to the photography device is realized.

In the present application, the position adjustment of the carrying body 10 can be operated simply and easily. The user experience is improved.

In some embodiments, the light-transmitting portion 11 is a through hole 12 that penetrates through the carrying body 10, which facilitates to save materials and low cost. In this embodiment, the through hole 12 is preferably circular, and the photographic auxiliary component such as the filter is circular and installed at the through hole 12. Each of the connecting arms 20 and each of the first sliding slots 22 extend along a radial direction of the circular through hole 12.

Of course, in other embodiments, the light-transmitting portion 11 can also be other shapes, such as, but not limited to, square, oval, polygon, etc.

Preferably, in this embodiment, the through hole 12 is provided with an internal thread 13 at the inner circumferential surface thereof. The photographic auxiliary component 102 such as the filter has an external thread 104 formed on its outer circumferential surface. The internal thread 13 of the through hole 12 is in threaded engagement with the external thread 10 of the photographic auxiliary component 102 to thereby connect the photographic auxiliary component 102 to the carrying body 10 of the mounting bracket 100, which is simple in structure, convenient for disassembly and assembly. The connection between the photographic auxiliary component 102 and the carrying body 10 of the mounting bracket 100 is stable which ensures stability of photography.

Of course, in other embodiments, the photographic auxiliary component can be connected to the mounting bracket 100 by other ways such as, but not limited to, magnetic attraction connection, snap connection, etc.

Referring to FIGS. 2 to 4, in some embodiments, the number of the connecting arms 20 is two.

The carrying body 10 includes a first annular body 14 and a second annular body 15, the second annular body 15 is rotatably connected to the first annular body 14, the first annular body 14 is connected to one of the connecting arms 20, and the second annular body 15 is connected to the other connecting arm 20.

The light-transmitting portion 11 includes a through hole 12 that penetrates through the first annular body 14.

The first annular body 14 and the second annular body 15 can be rotated and locked relative to each other. By rotating one of the first annular body 14 and the second annular body 15 relative to the other, the distance or included angle between the two connecting arms 20 can be adjusted, so that the positions of the fasteners 30 in the first sliding slots 22 can be adjusted. Thus, the position adjustment of the carrying body 10 is more flexible.

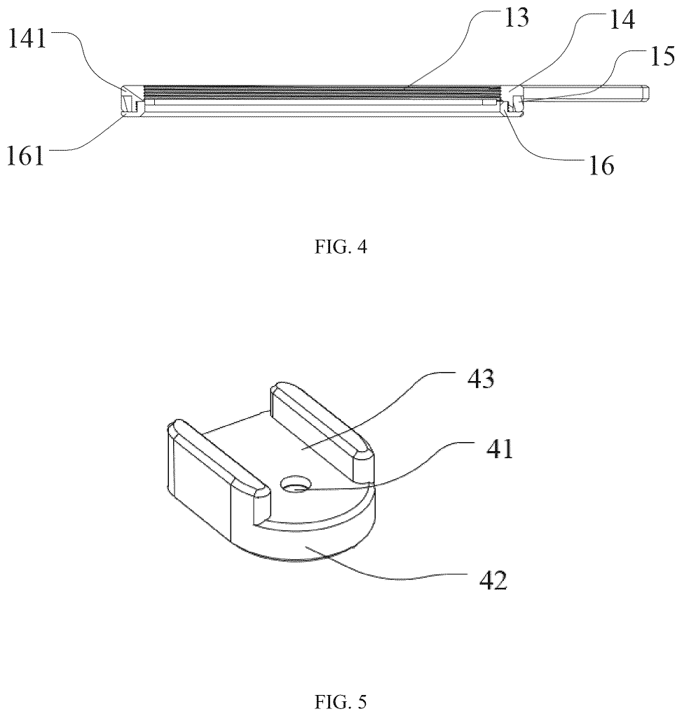

In some embodiments, referring also to FIG. 4, the carrying body 10 further includes a third annular body 16 which connects the first annular body 14 and the second annular body 15.

Specifically, the first annular body 14 has a first connecting thread, and the third annular body 16 has a second connecting thread, the first connecting thread is in threaded engagement with the second connecting thread to thereby connect the first annular body 14 and the third annular body 16. The first connecting thread is an internal thread formed on the inner surface of one end of the first annular body 14, and the second connecting thread is an external thread formed on the outer surface of the third annular body 16. The third annular body 16 can be inserted into the end of the first annular body 14 with the first connecting thread in threaded engagement with the second connecting thread. The structure is simple, easy to disassemble and assemble, and the connection is stable.

The outer wall of the first annular body 14 is provided with a first limiting portion 141 which protrudes outwardly from the outer wall of the first annular body 14, and the outer wall of the third annular body 16 is provided with a second limiting portion 161 which protrudes outwardly from the outer wall of the second annular body 16. The second limiting portion 161 is spaced from the first limiting portion 141 in the axial direction the annular bodies 14/16 such that an annular sliding groove is formed between the first limiting portion 141, the second limiting portion 161 and the outer wall of the first annular body 14 or the outer wall of the third annular body 16. The second annular body 15 is located in the annular sliding groove and can rotate around the first annular body 14. The first limiting portion 141 cooperates with the second limiting portion 161 to prevent the second annular body 15 from failing off the first annular body 14.

In this embodiment, the first annular body 14 is further provided with an internal thread 13 that is used to cooperate with the external thread on the outer wall of the photographic auxiliary component. The internal thread 13 and the first connecting thread are distributed on the inner surface of the first annular body 14 along the axial direction of the first annular body 14. The first connecting thread has a diameter greater than that of the internal thread 13.

Referring to FIGS. 2 and 5, in some embodiments, the mounting bracket 100 further includes a limiting member 40 which is provided between the connecting arm 20 and the photography device. The limiting member 40 is used to limit the movement range of the connecting arm 20 and prevent the connecting arm 20 from shifting leftward and/or rightward. The limiting member 40 defines a through hole 41 to allow the fastener 30 to pass therethrough.

Specifically, the limiting member 40 includes a limiting body 42. The surface of the limiting body 42 is concaved inward to form a limiting slot 43. A part of the connecting arm 20 is received in the limiting slot 43. The limiting slot 43 is in communication with the through hole 41. The connecting arm 20 is slidable in the limiting slot 43 which can guide sliding movement of the connection arm 20 and improve the connection stability between the connecting arm 20 and the photography device, making it less likely to loosen.

In some embodiments, the fastener 30 is cylindrical, and at least one fastener 30 has an operation end 302 exposed outside the carrying body 10. The operation end 302 has an anti-slip portion 304 provided on the outer circumference thereof. In this embodiment, a nut is fitted onto the operation end 302, and the anti-slip portion 304 is a rough surface arranged on the outer surface of the nut, which facilitates users to grip the fastener 30 during tightening or loosening the fastener 30. The whole circumferential surface of the anti-slip portion 304 is rough, increasing the roughness of the anti-slip portion 304 gripped by fingers of a user and increasing friction between the anti-slip portion 304 and the fingers to thereby improve the anti-slip effect.

This application also provides a filter unit which includes a filter and the aforementioned mounting bracket 100. The filter is the photographic auxiliary component. Since this filter unit adopts all the technical solutions of the aforementioned embodiments of the mounting bracket 100, the filter unit of this application also has all the beneficial benefits brought by the aforementioned embodiments of the mounting bracket 100, which will not be repeated here. The connection way between the filter and the mounting bracket 100 can be a snap connection, threaded connection, magnetic attraction connection, etc. Users can choose one of the above-mentioned connection ways according to actual needs. The filter can be a UV (ultraviolet) filter, skylight filter, polarizing filter, ND (neutral density) filter, fog filter, etc., which can be selected according to the application environment and imaging requirements to satisfy different photographing requirements of users.

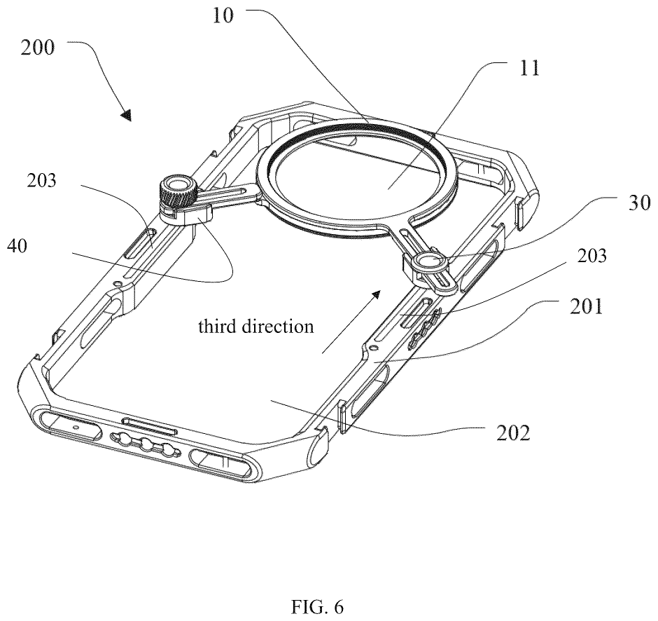

Referring to FIGS. 6-8B, the present application further provides a photography auxiliary device 200, which is configured to be detachably mounted to a mobile terminal 400 with a photography device 402. In this embodiment, the mobile terminal 400 can be a smartphone, iPad, or camera, etc. The photography device 402 comprises multiple camera lenses 404.

The photography auxiliary device 200 comprises a connecting bracket 201 which can be detachably connected to the mobile terminal 400, the mounting bracket 100 described above or the filter unit described above, and at least two fasteners 30. The connecting bracket 201 comprises a connecting structure 202 and at least two second sliding slots 203 spaced apart from each other. Each fastener 30 is inserted through a corresponding first sliding slot 22, the through hole 41 of the corresponding limiting member 40, and into a corresponding second sliding slot 203.

Since the photography auxiliary device 200 adopts all the technical solutions of the aforementioned embodiments of the mounting bracket 100, the photography auxiliary device 200 of this application also has all the beneficial effects brought by the aforementioned embodiments of the mounting bracket 100, which will not be repeated here.

In this embodiment, the connecting bracket 201 is a square hollow frame, including two first side walls extending in the length direction of the connecting bracket 201 and two second side walls extending in the width direction of the connecting bracket 201. The two second sliding slots 203 are respectively defined in the two first side walls, with the extension direction of the second sliding slots 203 being parallel to the length direction of the connecting bracket 201. The extension direction of the second sliding slots 203 is named as a third direction. An acute angle is formed between the third direction and the first direction. The positions of the fasteners 30 in the first sliding slots 22 and the second sliding slots 203 are adjustable, allowing the carrying body 10 of the mounting bracket 100 to move relative to the connecting bracket 201, to thereby achieve position adjustment of the carrying body 10 relative to the connecting bracket 201 in the length and width directions of the connecting bracket 201. Thus, position adjustment between the photography auxiliary component 102 and the photography device 402 of the mobile terminal 400 in the length and width directions of the connecting bracket 201 can be realized. The operation is convenient. The length direction of the connecting bracket 201 is parallel to the length direction of the mobile terminal 400, and the width direction of the connecting bracket 201 is parallel to the width direction of the mobile terminal 400.

In some embodiments, the connecting structure 202 is a cavity 204 for receiving the mobile terminal 400. The mobile terminal 400 can be fixedly suspended in the cavity 204 via a clamp 210 which is fixed to the mobile terminal 30 and the side walls of the connecting bracket 201. Specifically, opposite ends of the clamp 210 are respectively connected to the two first side walls of the connecting bracket 201 and a middle portion of the clamp 210 is fixed to the mobile terminal 400. The photography auxiliary device 200 can be directly fitted over the mobile terminal through the cavity 204. The connecting structure 202 has a simple structure, and is convenient for quick disassembly and assembly. Alternatively, in other embodiments, the connecting structure 202 can also adopt other structures, such as, but not limited to, using a mobile phone back clip to clip on the back of the mobile phone.

In summary, the above-described mounting bracket 100 comprises at least two spaced connecting arms 20 each of which has a first sliding slot 22. The fasteners 30 are capable of passing through the corresponding first sliding slots 22 and entering into the second sliding slots 203 on the connecting bracket 20 to thereby detachably connect the mounting bracket 100 to the mobile terminal 400. The carrying body 10 and the photography auxiliary component 102 are detachably assembled together. Therefore, the photography auxiliary device 200 has a modular structure, which can be disassembled or assembled according to actual needs. It is convenient for assembly. Relative installation positions between modules can be adjusted flexibly. Thus, the photography auxiliary device 200 has a good compatibility.

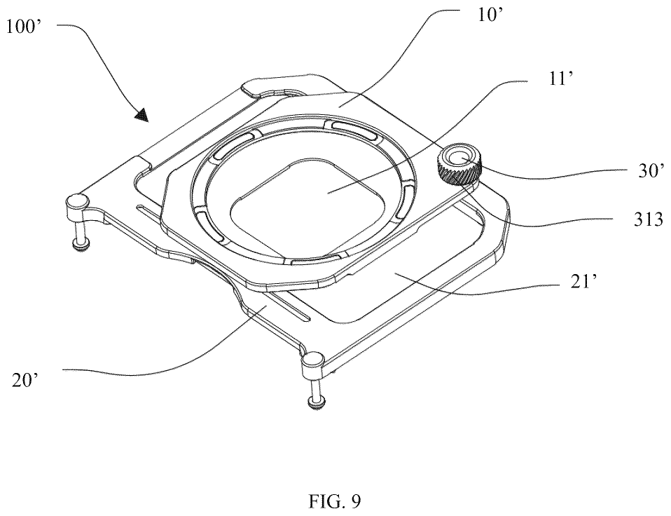

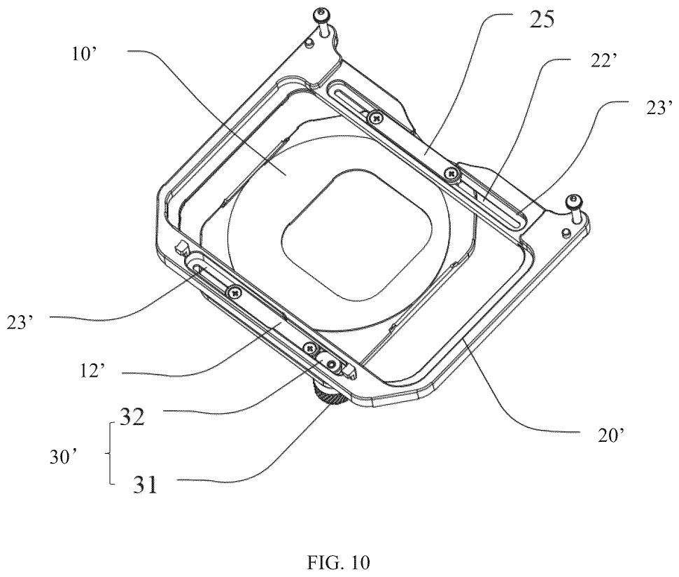

FIGS. 9 and 10 illustrate a mounting bracket 100′ in accordance with another embodiment of the present invention.

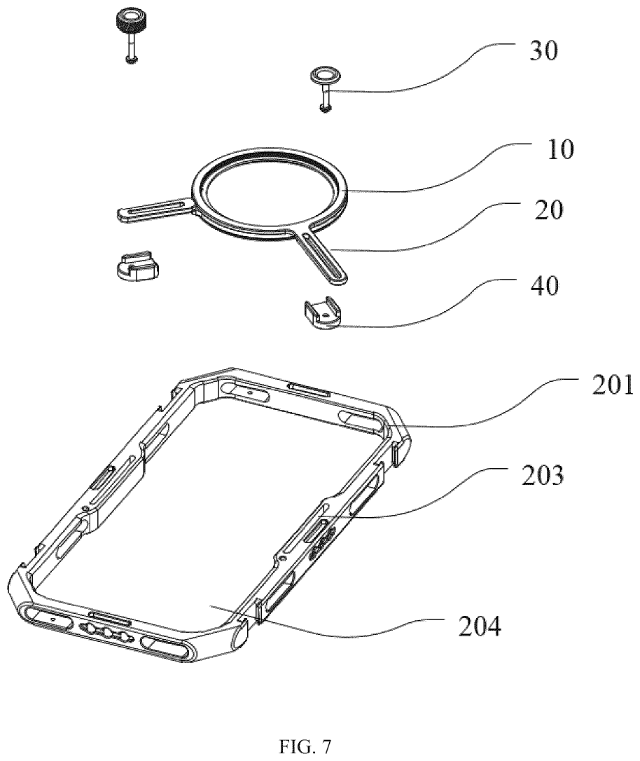

Referring to FIGS. 9 and 10, in this embodiment, the mounting bracket 100′ includes a carrying body 10′ for carrying a photographic auxiliary component 102 (see FIG. 7) and a mounting member for mounting the carrying body 10′ in front of a camera lens 404 of a photography device 402 of a mobile terminal 400 (see FIG. 8B). In this embodiment, the mounting member is a mounting frame 20′, specifically, the mounting frame 20′ is a substantially square hollow frame, and the middle of the frame 20′ forms a second light-transmitting portion 21′ for light to pass through. In use, the second light-transmitting portion 21′ is located in front of the camera lens 404 of the mobile terminal 400 to allow light to pass through and then enter into the camera lens 404 of the mobile terminal 400.

The carrying body 10′ is used for detachably mounting the photographic auxiliary component 102 thereon and is arranged at one end of the mounting frame 20′ in the axial direction of the light-transmitting portion 21′. The carrying body 10′ forms a first light-transmitting portion 11′, which is aligned to the second light-transmitting portion 21′ for light to sequentially pass through the first light-transmitting portion 11′ and the second light-transmitting portion 21′ before entering into the camera lens. In this embodiment, the photographic auxiliary component 102 is mounted at the first light-transmitting portion 11′ of the carrying body 10′. When the photographic auxiliary component 102 is a filter, it can be used to filter light to thereby eliminate the impact of ultraviolet lights and stray light in natural light on sensitivity of film. In addition, the photographic auxiliary component 102 can protect the camera lens.

The detachable mounting ways between the mounting frame 20′ and the photography device, and between the carrying body 10′ and the photographic auxiliary component 102, can be snap connections, threaded connections, and magnetic attraction connections, etc., which are convenient for quick disassembly and assembly, making it easy for users to use.

The mounting bracket 100′ further comprises a connecting member 30′ for movably connecting the mounting frame 20′ and the carrying body 10′ to lock the carrying body 10′ to the mounting frame 20′ or unlock the mounting frame 20′ from the carrying body 10′, making the mounting bracket 100′ of this embodiment modular in structure. Users can disassemble or assemble the mounting bracket 100′ according to their actual needs, and the assembly and disassembly is convenient. The relative position of the carrying body 10′ relative to the mounting frame 20′ can be flexibly adjusted such that the mounting bracket 100′ has a good compatibility.

In some embodiments, one of the mounting frame 20′ and the carrying body 10′ has a first sliding slot 22′, and the other has a slider 12′ that is slidable in the first sliding slot 22′. The connecting member 30′ extends through the first sliding slot 22′ and locks the carrying body 10′ to the mounting frame 20′.

In this embodiment, cooperation of the slider 12′ and the first sliding slot 22′ facilitates to adjust the relative position between the mounting frame 20′ and the carrying body 10′. The relative position between the mounting frame 20′ and the carrying body 10′ can be adjusted smoothly. After the slider 12′ slides in the first sliding slot 22′ to cause the carrying body 10′ to reach a preset position, the carrying body 10′ can be locked to the mounting frame 20′ by the connecting member 30′ which extends through the first sliding slot 22′ to lock the carrying body 10′ and the mounting frame 20′ together. Thus, position adjustment between the photographic auxiliary component mounted in the carrying body 10′ and the photography device connected to the mounting frame 20′ is achieved. The operation is convenient, and it is easy for users to operate.

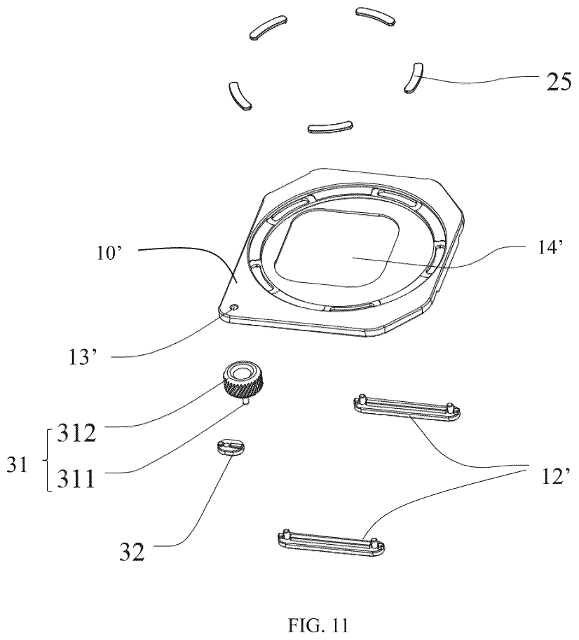

In some embodiments, referring to FIGS. 10 and 11, the mounting frame 20′ comprises a first sliding slot 22′, and the carrying body 10′ has a through hole 13′ that faces the first sliding slot 22′. The connecting member 30′ includes a first fastener 31 and a limiting block 32. The first fastener 31 includes a threaded rod 311 and a nut 312. The threaded rod 311 sequentially passes through the through hole 13′ and the first sliding slot 22′, the nut 312 is located on a side of the carrying body 10′ that is opposite to the mounting frame 20′, and the nut 312 is connected to one end of the threaded rod 311. In this embodiment, the threaded rod 311 is vertically extended through the through hole 13′ and the first sliding slot 22′. The nut 312 and the limiting block 32 are located at opposite sides of the mounting frame 20′ and parallel to each other.

The limiting block 32 is located on the side of the mounting frame 20′ that is opposite to the carrying body 10′, and the limiting block 32 is threaded to the end of the threaded rod 311 that is away from the nut 312, the top surface of the limiting block 32 abuts against the bottom surface of the mounting frame 20′. The limiting block 32 cooperates with the first fastener 31 to lock the carrying body 10′ to the mounting frame 20′. The connection between the carrying body 10 and the mounting frame 20′ is stable and not easy to loosen.

In some embodiments, there are two first sliding slots 22′ which are defined in opposite sides of the mounting frames 20′ respectively. Correspondingly, two sliders 12′ are provided, each slider 12 is inserted and slidable in one first sliding slot 22′, and the limiting block 32 is adjacent to one of the sliders 12′.

In this embodiment, the first sliding slot 22′ extends along the length direction of the mounting frame 20′. Since the two first sliding slots 22′ are spaced apart in the width direction of the mounting frame 20′ and set opposite to each other on the mounting frame 20′, the carrying body 10′ can only slide along the length direction of the mounting frame 20′. Therefore, in this embodiment, one first fastener 31 can lock the carrying body 10′ to the mounting frame 20′. Thus, the structure is simple, the operation is convenient and fast, saving time and labor.

In some embodiments, the outer circumference of the nut 312 is provided with an anti-slip portion 313. In this embodiment, the anti-slip portion 313 is a rough surface arranged on the outer circumference of the nut 312, which facilitates users to grip the nut 312 during tightening or loosening the first fastener 31, making it convenient for users to adjust the relative position between the photographic auxiliary component 102 and the photography device 402. The whole circumferential surface of the anti-slip portion 312 is rough to form the anti-slip portion 313, increasing the friction between the nut 312 and fingers of the users to thereby improve the anti-slip effect.

In some embodiments, the side of the mounting frame 20′ that is opposite to the carrying body 10′ is provided with a limiting slot 23′. The limiting slot 23′ is in communication with the first sliding slot 22′, the width of the limiting slot 23′ is greater than the width of the first sliding slot 22′, and the length of the limiting slot 23′ is greater than or equal to the length of the first sliding slot 22′. The slider 12′ and the limiting block 32 are respectively located within the limiting slot 23′, playing a role in limiting the sliding range of the slider 12′. The slider 12′ and the limiting block 32 can be spaced apart or in contact with each other.

Specifically, referring to FIG. 13, the slider 12′ includes a sliding part 121 and a guiding part 122 that protrudes from the sliding part 121. The width of the sliding part 121 is greater than the width of the first sliding slot 22′, preventing the sliding part 121 from sliding out of the first sliding slot 22′, ensuring the stable connection between the mounting frame 20′ and the carrying body 10′. The sliding part 121 is received in the limiting slot 23′ and is slidable in the limiting slot 23′. The guiding part 122 extends through the first sliding slot 22′. The guiding part 122 is slidable in the first sliding slot 22′, thereby guiding the sliding direction of the carrying body 10′ relative to the mounting frame 20′and avoiding deviation the carrying body 10′ relative to the mounting frame 20′. The slider 12′ further comprises a connecting part 124 secured with the carrying body 10′ such that the slider 12′ and the carrying body 10′ are slidable together relative to the mounting member 20′. Specifically, the connecting part 124 comprises a pair of posts extending through the sliding slot 22′ and being engaged with the carrying body 10′.

In some embodiments, the second light-transmitting portion 21′ is a second through hole 24′ that penetrates through the mounting frame 20′, and the first light-transmitting portion 11′ is a first through hole 14′ that penetrates the carrying body 10′ and is aligned with the second through hole 24′. The first through hole 14′ and the second through hole 24′ allow light to pass through, and the photographic auxiliary component is mounted at the first through hole 14′. The mounting frame 20′ and the carrying body 10′ are both hollow structures, which facilitates to save material and low cost. In this embodiment, the first through hole 14′ and the second through hole 24′ are both rectangular. Alternatively, in other embodiments, the first through hole 14′ and the second through hole 24′ can also be other shapes, such as, but not limited to, circular, oval, polygonal, etc.

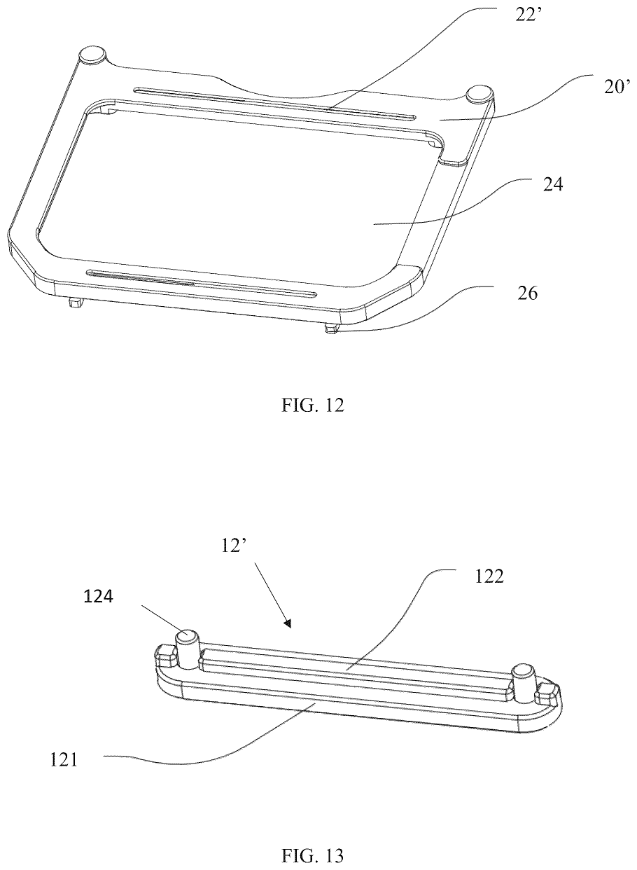

Referring to FIG. 12, the rectangular second through hole 24′ comprises a length which is greater than the length of the first sliding slot 22′ and a width. The two first sliding slots 22′ are respectively located at opposite sides of the rectangular second through hole 24′ in a width direction of the rectangular second through hole 24′. The length of the second through hole 24′ is greater than the length of the rectangular first through hole 14′ and the width of the rectangular second through hole 24′ is greater than the width of the rectangular first through hole 14′. Preferably, the projection of the first through hole 14′ in the axial direction of the first through hole 14′ falls within the projection of the second through hole 24′ in the axial direction of the second through hole 24′ when the slider 12′ slides in the first sliding slot 22′.

In some embodiments, the carrying body 10′ is provided with a magnetic attraction member 25 around the outer circumference of the first through hole 14′. The magnetic attraction member 25 is configured for magnetic attracting with the photographic auxiliary component 102. In this embodiment, the magnetic attraction member 25 can be a permanent magnet, and the photographic auxiliary component is a magnetic attraction type photographic auxiliary component which can include a magnetic attraction cooperating part, and the magnetic attraction cooperating part can be a magnet or a magnetic conductive material. The magnetic conductive material can be iron, cobalt, nickel, and their alloys and other magnetic metals. The magnetic attraction type photographic auxiliary component can be secured to the carrying body 10′ via magnetic attraction between the magnetic attraction member 25 of the carrying body 10′ and the magnetic attraction cooperating part of the magnetic attraction type photographic auxiliary component, which realizes fast assembly and disassembly. Operation is simple and convenient.

Alternatively, the magnetic attraction member 25 can be made of a magnetic conductive material such as iron or iron alloy. The magnetic attraction cooperating part of the magnetic attraction type photographic auxiliary component can be a permanent magnet.

In this embodiment, the magnetic attraction member 25 comprises multiple (e.g., 5) pieces, which are evenly distributed around the circumference of the first through hole 14′, enhancing the connection stability between the carrying body 10′ and the magnetic attraction type photographic auxiliary component. In this embodiment, each magnetic piece 25 has an arcuate shape. Of course, in other embodiments, the magnetic piece 25 can also be of other shapes, such as, but not limited to, circular, square, polygonal, etc.

In some embodiments, the first through hole 14′ is provided with an internal thread that is in threaded engagement with the outer thread formed on the outer wall of the photography auxiliary component 102 such as a filter. By using threaded connection of the external thread and the internal thread, the photography auxiliary component and the mounting bracket 100′ are connected together. The connection structure is simple such that disassembly and assembly of the connection structure is convenient. The connection structure is stable which improves stability of the photography device during shooting.

This embodiment further provides a filter unit which includes a filter and the aforementioned mounting bracket 100′, wherein the filter serves as a photography auxiliary component. Since this filter unit adopts all the technical solutions of the aforementioned embodiments of the mounting bracket 100′, the filter unit of this embodiment also has all the beneficial effects brought by the aforementioned embodiments of the mounting bracket 100′, which will not be repeated here.

The connection ways between the filter and the mounting bracket 100′ comprises any one or more of a snap connection, a threaded connection, and a magnetic attraction connection, etc., and users can choose the connection way according to their actual needs. The filter can be a UV filter, a skylight filter, a polarizing filter, an ND filter, a fog filter, etc., which can be selected according to the application environment and imaging requirements in order to satisfy different photographing requirements of users.

This embodiment further provides a photography auxiliary device 200′, which is configured to be detachably mounted to a mobile terminal 400 with a photography device. In this embodiment, the mobile terminal 400′ can be a smartphone, iPad, camera or other electronic equipment with photography devices.

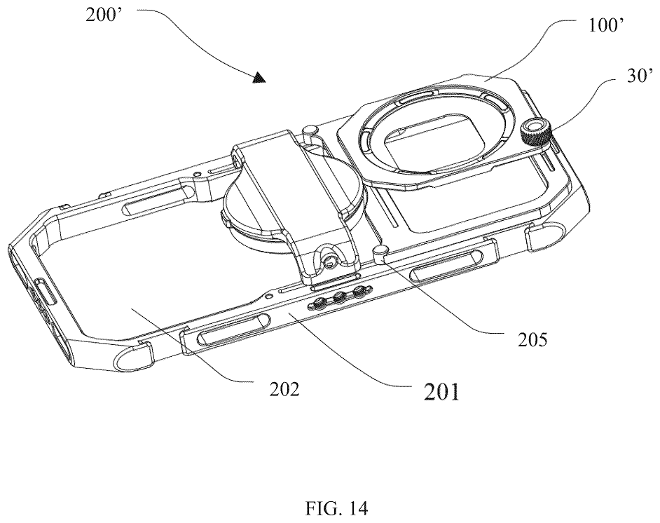

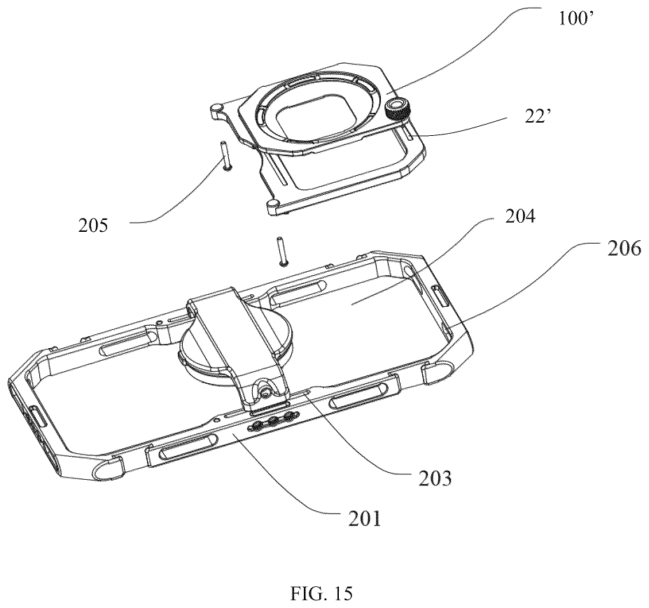

Referring to FIGS. 14-15, the photography auxiliary device 200′ includes a connecting bracket 201 and the above-mentioned mounting bracket 100′ or the previously mentioned filter assembly, and at least two second fasteners 205. The connecting bracket 201 comprises a connecting structure 202 for detachably connecting to a mobile terminal 400 and at least two second sliding slots 203 spaced apart. Each second fastener 205 is connected with the mounting bracket 100′ and slidable in one second sliding slot 203.

In this embodiment, the second sliding slot 203 is elongated and extends along the length direction of the connecting bracket 201. The second fasteners 205 are slidable in the corresponding second sliding slots 203 to drive the mounting bracket 100′ to slide relative to the connecting bracket 201 to thereby adjust the position of the photography auxiliary component 102 relative to the photography device of the mobile terminal 400. Thus, the photography auxiliary device 200′ is compatible with different mobile terminals 400 with photography devices at different positions. Specifically, the second sliding slots 203 extend along the length direction of the connecting bracket 201, while the first sliding slot 22′ of the mounting bracket 100′ extends along the width direction of the connecting bracket 201. Thus, the carrying body 10′ together with the photography auxiliary component 102, which is mounted on the mounting frame 20′, is allowed to move relative to the photography device of the mobile terminal 400 which is mounted to the connecting bracket 201 in the length and/or width direction of the connecting bracket 201 to be adjusted to an appropriate position.

Since the photography auxiliary device 200′ adopts all the technical solutions of the aforementioned embodiments of the mounting bracket 100′, the photography auxiliary device 200′ of this application also has all the beneficial effects brought by the aforementioned embodiments of the mounting bracket 100′, which will not be repeated here.

In some embodiments, the connecting structure 202 is a cavity 204 for receiving the mobile terminal 400 therein. The photography auxiliary device 200′ can be directly fitted over the mobile terminal 400 through the cavity 204. The connecting structure 202 has a simple structure, and is convenient for fast disassembly and assembly. Alternatively, in other embodiments, the connecting structure 202 can also adopt other structures, such as, but not limited to, using a mobile phone back clip to clip on the back of the mobile phone.

In some embodiments, a hook 26 and a groove 206 are provided between the mounting bracket 100′ and the connecting bracket 201. The hook 26 can be engaged in the groove 206.

In this embodiment, the hook 26 is arranged on the mounting bracket 100′, and the groove 206 is arranged on the connecting bracket 201. The hook 26 and the second fastener 205 are located on opposite sides of the mounting bracket 100′. Alternatively, in other embodiments, the hook 26′ can also be arranged on the connecting bracket 201, and the groove 206 can be arranged on the mounting bracket 100′.

When the mounting bracket 100′ and the connecting bracket 201 are assembled, the hook 26 is first engaged in the groove 206 to achieve alignment between the mounting bracket 100′ and the connecting bracket 201, and then the second fasteners 205 are extended through the second sliding slot 203 to achieve quick connection and locking. In the locked state, the hook 26 and the groove 206 provide support and securing functions for the mounting bracket 100′, ensuring a stable connection between the mounting bracket 100′ and the connecting bracket 201.

In summary, the mounting bracket 100′ of this embodiment applies a connecting member 30′ for detachably connecting the mounting frame 20′ and the carrying body 10′ and locking the carrying body 10′ to the mounting frame 20′, which is convenient for quick disassembly and assembly. Furthermore, the position of the connecting member 30′ relative to one of the carrying body 10′ and the mounting frame 20′ is adjustable, which makes the position of the camera auxiliary component relative to the photography device be adjustable conveniently. Therefore, the mounting bracket 100′ of this embodiment has a good compatibility.

The above description is merely some embodiments. It should be noted that for one with ordinary skills in the art, improvements can be made without departing from the concept of the present disclosure, but these improvements shall fall into the protection scope of the present disclosure.

What is claimed is:

1. A mounting bracket configured for detachably mounting a photographic auxiliary component in front of a camera lens of a photography device, comprising:
a carrying body configured for detachably carrying the photographic auxiliary component thereon, the carrying body comprising a first light-transmitting portion for allowing light to pass therethrough; and
a mounting member configured to mount the carrying body to the photography device to thereby mount the photographic auxiliary component in front of the camera lens of the photography device, the mounting member defining a sliding slot extending in a first direction to allow a fastener to pass through in a second direction perpendicular to the first direction, the fastener being slidable in the sliding slot in the first direction.

2. The mounting bracket according to claim 1, wherein the mounting member comprises at least two spaced connecting arms extending from the carrying body; and
each of the connecting arms defines one said sliding slot to allow one said fastener to pass through to detachably connect with the photography device.

3. The mounting bracket according to claim 2, wherein an acute angle is formed between the at least two spaced connecting arms; or
an intersection point of extended lines of the sliding slots is located at a center of the first light-transmitting portion.

4. The mounting bracket according to claim 1, wherein the first light-transmitting portion is a through hole passing through the carrying body.

5. The mounting bracket according to claim 4, wherein at least a portion of the through hole forms an internal thread configured to engage with an external thread formed on an outer wall of the photographic auxiliary component.

6. The mounting bracket according to claim 2, wherein the carrying body comprises a first annular body and a second annular body pivotably sleeved on the first annular body;
the at least two spaced connecting arms comprises a first connecting arm extending from the first annular body and a second connecting arm extending from the second annular body; and
the first light-transmitting portion is formed at the first annular body.

7. The mounting bracket according to claim 6, wherein the carrying body further comprises a third annular body connected to the first annular body and the second body;
the first annular body forms a first connecting thread, the third annular body forms a second connecting thread in threaded engagement with the first connecting thread; and
the first annular body comprises a first limiting portion formed at an outer wall thereof, the third annular body comprises a second limiting portion formed at an outer wall thereof, an annular groove is formed between the first limiting portion and the second limiting portion, and the second annular body is received in the annular groove.

8. The mounting bracket according to claim 1, wherein the mounting member further comprises a second light-transmitting portion such that light can sequentially pass through the first light-transmitting portion and the second light-transmitting portion before entering into the camera lens of the photography device;
the fastener is configured to connect the mounting member and the carrying body and lock the carrying body with the mounting member when being tightened; and
a position of the fastener relative to the mounting member or the carrying body is adjustable.

9. The mounting bracket according to claim 8, wherein the mounting member comprises a pair of said sliding slots located at opposite sides of the second light-transmitting portion, and the carrying body comprises a pair of sliders which are slidable in the sliding slots respectively; and
the fastener extends through one of said sliding slots for locking the carrying body with the mounting member.

10. The mounting bracket according to claim 9, wherein the mounting member and the second light-transmitting portion both are substantially rectangular; and
opposite ends of the second light-transmitting portion extend beyond opposite ends of each of the sliding slots.

11. The mounting bracket according to claim 9, wherein the carrying body defines a through hole aligned with one of the sliding slots;
the fastener comprises a threaded rod and a nut, the threaded rod extends through the through hole and said one of the sliding slots in sequence, and the nut is sleeved on an end of the threaded rod opposite to the mounting member; and
the mounting bracket further comprises a limiting block located at a side of the mounting member opposite to the carrying body and engaged with another end of the threaded rod.

12. The mounting bracket according to claim 11, wherein an anti-skip portion is provided at a circumferential surface of the nut; or
a pair of limiting slots is provided at a side of the mounting member opposite to the carrying body, and each of the limiting slots is in communication with a corresponding one of the sliding slots for receiving a correspond one of the sliders.

13. The mounting bracket according to claim 9, wherein the first light-transmitting portion is a first through hole passing through the carrying body, and the second light-transmitting portion is a second through hole passing through the mounting member.

14. The mounting bracket according to claim 13, wherein the carrying body comprises a magnetic attraction member arranged at a surface thereof opposite to the mounting member, the magnetic attraction member being arranged around the first through hole; or
the carrying body comprises an internal thread around the first through hole.

15. A filter unit comprising a filter and a mounting bracket according to claim 1, the filter acting as the photographic auxiliary component.

16. A photography auxiliary device configured to be detachably mounted to a mobile terminal with a photography device, comprising:
a mounting bracket according to claim 1; and
a connecting bracket configured to connect the mounting bracket to the mobile terminal, the connecting bracket comprising a connecting structure configured to detachably connect to the mobile terminal;
wherein a position of the carrying body relative to the connecting bracket is adjustable; and
the sliding slot is named as first sliding slot, the connecting bracket comprises a second sliding slot extending in a third direction which is angled to the first direction.

17. The photography auxiliary device according to claim 16, wherein the mounting member comprises two spaced connecting arms extending from the carrying body; and
each of the connecting arms defines one said first sliding slot;
the connecting bracket defines a pair of said second sliding slots; and
the photography auxiliary device comprises a pair of said fasteners each of which passes through one said first sliding slot and one said second sliding slot such that the carrying body is movable relative to the connecting bracket.

18. The photography auxiliary device according to claim 16, wherein the mounting bracket further includes a limiting member arranged between each of the connecting arms and the connecting bracket in the second direction; and
each limiting member defines a through hole in the second direction to allow the fastener to pass through and a limiting slot extending in the first direction to allow a corresponding one of the connecting arms to pass through.

19. The photography auxiliary device according to claim 16, wherein the carrying body defines a through hole, the fastener extends through the through hole and the first sliding slot such that a locking position of the carrying body locked with the mounting member is adjustable; and
the photography auxiliary device further comprises another fastener which extends through the second sliding slot such that a locking position of the mounting member locked with the connecting member is adjustable.

20. The photography auxiliary device according to claim 16, wherein a groove is arranged at one of the mounting bracket and the connecting bracket, and a hook is arranged at another one of the mounting bracket and the connecting bracket for engaging in the groove.
